(19) United States
(12) Patent Application Publication
(10) Pub. No.: US 2021/0143761 A1
(43) Pub. Date: May 13, 2021

(54) METHOD AND DEVICE FOR MOVING AN ACTUATOR OF AN ACTUATOR DEVICE INTO A TARGET POSITION, AND ACTUATOR DEVICE

(71) Applicant: ZF Friedrichshafen AG, Friedrichshafen (DE)

(72) Inventor: Felix BÖCKMANN, Bremen (DE)

(73) Assignee: ZF Friedrichshafen AG, Friedrichshafen (DE)

(21) Appl. No.: 16/623,727

(22) PCT Filed: May 16, 2018
(86) PCT No.: PCT/EP2018/062673

§ 371 Date: Dec. 17, 2019

(30) Foreign Application Priority Data
Jun. 19, 2017 (DE) 10 2017 210 199.7

(51) Int. Cl. H02P 6/17; H02P 29/60; H02K 7/06; H02P 6/18; H02P 6/08

(52) U.S. Cl. CPC H02P 6/17; H02P 29/60; H02P 6/08; H02P 6/18; H02K 7/06

(57) ABSTRACT

The present invention relates to a method for moving an actuator in an actuator device to a target position, wherein the actuator device comprises at least a motor, a transmission, and an actuator. The method comprises at least a determining step, an ascertaining step, a detecting step, and a generating step. A rotational rate of the motor is determined in the determining step using a motor voltage, a motor current, and a motor temperature. A speed of the actuator is ascertained in the ascertaining step using the rotational rate and a gear ratio translation factor of the transmission. A reconstructed position of the actuator is detected in the detecting step using the speed and a travel time. The control signal is generated in the generating step, which is configured to cause the actuator to move to the target position based on the reconstructed position.

### RELATED APPLICATIONS

This application is a filing under 35 U.S.C. § 371 of International Patent Application PCT/EP2018/062673, filed May 16, 2018, claiming priority to German Patent Application 10 2017 210 199.7, filed Jun. 19, 2017. All applications listed in this paragraph are hereby incorporated by reference in their entireties.

### TECHNICAL FIELD

The present invention relates to a method and a device for moving an actuator of an actuator device into a target position, and an actuator device that has a corresponding device.

### SUMMARY

With an actuator coupled to a DC motor via a transmission, a rotational movement of the permanently excited DC motor is converted into a translatory actuation of the actuator by the transmission. In order to keep the complexity of the sensor system to a minimum, discrete signals are used for detecting the position of the actuator. In this case, it is only detected whether the actuator is in the target position or the starting position.

Based on this, the present approach results in an improved method and an improved device for moving an actuator in an actuator device to a target position, and an actuator device that has an improved device according to the independent claims. Advantageous embodiments can be derived from the dependent claims and the following description.

The method presented herein advantageously enables a reconstruction of a current position of an actuator coupled to a motor, using motor variables that can be easily detected, i.e. motor voltage, motor current, and motor temperature, by means of which it is possible to move the actuator to a target position.

A method for moving an actuator in an actuator device to a target position, wherein the actuator device comprises at least a motor, a transmission, and the actuator coupled to the motor via the transmission, comprises the following steps:
Determining a rotational rate of the motor based on a motor voltage, a motor current, and a motor temperature;
Ascertaining a speed of the actuator based on the rotational rate and a gear ratio translation factor of the transmission;
Detecting a reconstructed position of the actuator based on the speed and a travel time; and
Generating a control signal configured to cause the actuator to move into the target position based on the reconstructed position.

The motor voltage can represent a voltage signal input to a voltage sensor via an interface. The motor current can represent a current signal input to a current sensor via an interface. The motor temperature can represent a temperature signal input to a temperature sensor via an interface. The motor temperature can represent an inner temperature or an outer temperature of the motor according to different embodiments. The rotational rate of the motor can relate to a rotational movement of a shaft in the motor. The speed of the actuator can result from the rotation of the shaft in the motor transferred to the actuator via the transmission. The reconstructed position can be understood to be a current position of the actuator. A starting position of the actuator can be predefined. The travel time can represent the time travelled from the starting position. A control signal is generated in the generating step that is configured to cause the actuator to move to the target position based on the reconstructed position. The control signal can be, e.g., a control voltage, a control current, or an actuation signal for actuating a regulator that regulates the operation of the motor. It is possible with the method presented herein to check where the actuator is located using the motor variables described above. Based on this, the actuator can subsequently be moved to the target position. A simple control loop can be used for this.

The method can thus have a comparison step that can be executed before the generating step, for example, wherein a comparison of the target position with the reconstructed position is carried out in this comparison step. The control signal for controlling the motor can then be advantageously be determined using the comparison result. The target position can be subtracted from the reconstructed position, for example, in the comparison step in order to determine the control signal, which is advantageously configured to cause the actuator move based on the comparison result, which indicates the difference between the reconstructed position and the target position.

The reconstructed position can be detected in the detecting step, e.g., by an integration of the speed of the actuator over the travel time.

According to an advantageous embodiment of the method presented herein, the rotational rate can be determined in the determining step based on engine characteristics. By way of example, the rotational rate can be determined by means of the engine characteristics presented in the form of a stored digital table. As a result, the rotational rate can be quickly and easily collated by means of characteristic curves. Because a motor temperature cannot always be precisely measured, it may be sufficient here to distinguish between a high a low temperature, depending on the required temperature range, and to reduce the engine characteristics table accordingly. As a result, the motor temperature can have a temperature range comprising just two values according to one embodiment.

An intermediate rotational rate can first be determined in the determining step, for example, based on the motor current, the motor temperature, and another engine characteristic, wherein the rotational rate can be determined using the intermediate rotational rate, the motor voltage, and a correction factor. The intermediate rotational rate can be understood to be a preliminarily determined rotational rate. The correction factor can represent a quotient of a measured voltage divided by a measurement voltage in this case. This correction factor is used to reduce complexity, such that the other engine characteristic only needs to be measured or simulated at one voltage.

The control signal can be generated in the generating step, which is configured to provide a voltage for translating the actuator to the target position on the motor, which is coupled to the actuator via the transmission.

A device is configured to actuate and/or execute the steps of the method in corresponding units, in any of the variations described herein.

This device can be an electric device that processes electrical signals, e.g. sensor signals, and outputs control signals based thereon. The device can have one or more interfaces, which can be in the form of hardware and/or software. A hardware interface can be part of an integrated circuit, for example, in which functions of the device are implemented. The interfaces can also be discrete, integrated circuits, or at least be composed of discrete components. A software interface can be a software module on a microcontroller, in addition to other software modules.

An actuator device has at least a motor, a transmission, and an actuator, wherein the motor is coupled to the actuator via the transmission. In addition, the actuator device also contains the device presented above, which is configured to generate the control signal for the motor.

A computer program product containing programming code is also advantageous, which can be stored on a machine readable medium, e.g. a solid state drive, a hard disk, or an optical memory, and is used for executing the method according to any of the embodiments described above when the program is executed on a computer or a device.

### BRIEF DESCRIPTION OF THE DRAWINGS

Exemplary embodiments of the invention presented herein are depicted in the drawings, and explained in greater detail in the following description. Therein:

FIG. 1 shows a schematic illustration of an actuator device according to an exemplary embodiment;

FIG. 2 shows a schematic illustration of an actuator device according to an exemplary embodiment;

FIG. 3 shows a schematic illustration of a device for moving an actuator in an actuator device to a target position according to an exemplary embodiment;

FIG. 4 shows a schematic illustration of a device according to an exemplary embodiment; and

FIG. 5 shows a flow chart for a method for moving an actuator in an actuator device to a target position according to an exemplary embodiment.

In the following description of preferred exemplary embodiments of the present invention, the same or similar reference symbols are used for the elements shown in the figures that have similar functions, wherein there shall be no repetition of the descriptions of these elements.

### DETAILED DESCRIPTION

FIG. 1 shows a schematic illustration of an actuator device 100 according to an exemplary embodiment. The actuator device 100 has at least a motor 105, a transmission 110, an actuator 115, and a device 120. The motor 105 is coupled to the actuator 115 via the transmission 110. The transmission 110 is configured to translate a rotational movement 125 of the motor 105 to a linear movement 130 of the actuator 115. According to this exemplary embodiment, the transmission 110 is coupled to a shaft 132 in the motor 105.

The device 120 is configured to generate a control signal 135 for the motor 105. The control signal 135 is configured to control an operation of the motor 105 such that the actuator 115 is moved from the current position to a target position.

FIG. 2 shows a schematic illustration of an actuator device 100 according to an exemplary embodiment. This can be the actuator device 100 described in reference to FIG. 1.

To move the actuator 115 to the target position 200, the device 120 is configured to determine a rotational rate 202 of the motor 105 based on a motor voltage 205, a motor current 210, and a motor temperature 215. For this, the device 120 according to this exemplary embodiment contains a position reconstruction device 220 that is configured to input corresponding signals that have been or are detected and provided according to an exemplary embodiment by a motor voltage sensor, a motor current sensor, and a temperature sensor.

The device 120, i.e. the position reconstruction device 220 of the device 120 according to this exemplary embodiment, is also configured to ascertain the speed 225 of the actuator 115, e.g. the speed 225 of a linear movement of the actuator 115, based on the rotational rate 202 and a translation factor of the transmission 110. The device 120 is configured to detect a reconstructed position 235 of the actuator 115 based on the speed 225 and a travel time 230. The position reconstruction device 220 according to this exemplary embodiment inputs a signal representing the travel time 230 for this. The device 120 is configured to generate the control signal 135 based on the reconstructed position 235, which is configured to cause the actuator 115 to move to the target position 200. According to this exemplary embodiment, the device 120 has a regulating device 245 for this, which is configured to output the control signal 135 to the motor 105.

The device 120 according to this exemplary embodiment optionally has a comparison device 250 that is configured to first carry out a comparison between the target position 200 and the reconstructed position 235. The comparison device 250 inputs corresponding signals, and determines the control signal 135 based on a comparison result. By way of example, a signal representing the target position 200 can be output from a memory. A signal representing the reconstructed position 235 can be provided by the position reconstruction device 220.

The regulating device 245 generates the control signal 135 according to this exemplary embodiment, which provides a voltage for moving the actuator 115 to the target position 200 on the motor 105, which is coupled to the actuator 115 via the transmission 110.

The steps carried out by the device 120 can be carried out continuously, such that a current reconstructed position 235 is continuously determined and can be used to guide the actuator to the target position 200. By way of example, a reconstructed position 235 can be updated until the last reconstructed position 235 is the same as the target position 200.

Exemplary embodiments of the actuator device 100 and the device 120 shall now be described again, but differently, below:

The device 120 presented herein is configured to actuate or execute a method for reconstructing a translatory actuator position form measured motor variables.

In differing from devices that ascertain a rotational rate of a motor from a voltage and/or a torque of the motor from a current based on characteristic curves, the device 120 presented herein ascertains the rotational rate 202 from a combination of the motor current 210 and motor voltage 205, as well as the motor temperature 215. This rotational rate 202 is calculated based on the gear ratio of the transmission 110. The system is expanded with a time measurement in the form of the travel time 230, by means of which it is possible to ascertain the reconstructed position 235 from the speed 225 through an integration thereof over time.

The device 120 therefore advantageously takes a temperature dependent motor characteristic (engine characteristic) into account. Accordingly, not only is a signal obtained that is proportional to a rotational rate, but also, a distinct engine operating point is also determined. A time measurement is also taken, which forms the basis for ascertaining the reconstructed position 235. The gear ratio of the transmission 110 and the conversion to a translatory movement are also taken into account.

The product is the actuator 115, which converts the rotational movement of a permanently excited DC motor 105 to a translatory actuation movement via the transmission 110. In order to keep the complexity of the sensor system to a minimum, discrete signals are frequently used for detecting a position. As a result, it is only detected whether the actuator is at a target position or a starting position.

In order to be able to regulate the actuator device 100 herein, the position and/or speed 225 are continuously ascertained. A regulation offers advantages regarding precision as well as the acoustics. Because a load is not known, and is also not constant, control thereof is frequently not optimal in known systems. The current rotational rate 202 can be ascertained by the device 120 presented herein via characteristic curves from the more easily ascertained variables comprising the motor current 210, motor voltage 205, and motor temperature 215. This in turn can be used to ascertain the current position in the form of the reconstructed position 235 via the gear ratio and integration over time.

The approach presented herein accordingly describes a method enabled by the device 120 for reconstructing the speed 225 and/or position of the actuator 115 from the more easily measured variables in the form of the motor current 210, the motor voltage 205, and the motor temperature 215.

The fundamental circumstances can be described in the following manner: A distinct rotational rate torque characteristic curves can be derived from the voltage and temperature. The motor voltage 210 is proportional to the torque. As a result, an explicit determination of the current operating point can be obtained from the rotational rate torque characteristics to which the rotational rate is explicitly dedicated. In simplified terms, the motor torque can be explicitly dedicated to each combination of voltage, current and temperature. This is used by means of engine characteristics containing the three aforementioned input variables. See also, FIG. 3.

In addition, the speed 225 of the translatory part of the actuator 115 is ascertained via the gear ratio of the transmission 110, also referred to as the actuator gearing, in a special case according to this exemplary embodiment of a gear ratio of a spur wheel section and an incline of a spindle. The system also contains the time measurement starting at the starting point when a voltage is applied. The speed 225 can then be integrated over time, and because the starting position in the actuator 115 is known, a conclusion can be drawn from this regarding the current position in the form of the reconstructed position 235. These variables are then used for regulating the position, as is the case in the control circuit shown in this figure. The reconstructed signal may be imprecise due to imprecisions in the measurements/characteristic curves. In combination with a binary target and starting position detection, the target position can be approached precisely through a correction. Because the speed 225 is also ascertained, it can also be used as a control variable.

FIG. 3 shows a schematic illustration of a device 120 for moving an actuator in an actuator device to a target position according to an exemplary embodiment. This can be the device 120 described in reference to FIG. 2.

According to this exemplary embodiment, the device 120 determines the rotational rate 220 based on the engine characteristics 300 referred to in reference to FIG. 2. The engine characteristics 300 are predetermined according to one exemplary embodiment, and stored, e.g. in a memory. The device 120 also detects the reconstructed position 235 through an integration of the speed 225 over the travel time 230 in an integrating device 310. The translation factor 315 is used to determine the speed 225 from the rotational rate 202, which relates to a gear ratio of the transmission.

The ascertainment of the rotational rate 202 from the three variables, motor voltage 205, motor current 210, and motor temperature 215, can be implemented in different ways (cf. FIG. 3 and FIG. 4). The motor temperature 215 frequently cannot be measured precisely. Depending on the required temperature range, it may be sufficient to distinguish between high and low temperatures, for example, and to thus reduce the engine characteristics table 300 accordingly. The rotational rate torque characteristic curve is proportional to the motor voltage 205.

FIG. 4 shows a schematic illustration of a device 120 for moving an actuator in an actuator device to a target position according to an exemplary embodiment. This can be the device 120 described in reference to FIG. 2.

According to this exemplary embodiment, the device 120 determines an intermediate rotational rate based on the motor current 210, the motor temperature 215, and a further engine characteristic 400, wherein the rotational rate 202 is determined using on the intermediate rotational rate, the motor voltage 205, and a correction factor 405. The engine characteristic 400 is predetermined according to one exemplary embodiment, and stored, e.g., in a memory.

The correction factor 405 can be configured to minimize the complexity and represents a measured voltage divided by a measurement voltage. The correction factor 405 is predetermined, according to one exemplary embodiment, such that the other engine characteristic 400 only needs to be measured or simulated at one voltage.

FIG. 5 shows a flow chart for a method 500 for moving an actuator in an actuator device to a target position according to an exemplary embodiment. This can be the actuator device described in reference to FIGS. 1 and 2. The method 500 can be executed and/or actuated by one of the devices described in reference to FIGS. 1 to 4.

The method 500 comprises at least one determining step 505, one ascertaining step 510, one detecting step 515, and one generating step 520. In the determining step 505, a rotational rate of the motor is determined using a motor voltage, a motor current, and a motor temperature. In the ascertaining step 510, the speed of the actuator is ascertained based on the rotational rate and a gear ratio translation factor for the transmission. In the detecting step 515, a reconstructed position of the actuator is detected based on the speed and a travel time. In the generating step 520, the control signal is generated, which is configured to cause the actuator to move to the target position based on the reconstructed position.

The exemplary embodiments described below and an additional comparison step 525 are optional.

According to this exemplary embodiment, the rotational rate is determined in the determining step 505 based on an engine characteristic. According to this exemplary embodiment, an intermediate rotational rate is determined for this in the determining step 505 based on the motor current, the motor temperature, and another engine characteristic, wherein the rotational rate is determined using the intermediate rotational rate, the motor voltage, and a correction factor.

According to this exemplary embodiment, the reconstructed position is detected in the detecting step 515 through an integration of the speed over the travel time.

The control signal is generated in the generating step 520, which is configured to provide a voltage for moving the actuator to the target position on the motor, which is coupled to the actuator via the transmission.

The method 500 also comprises a comparison step 525 according to this exemplary embodiment, in which the target position and the reconstructed position are compared, wherein the control signal for controlling the motor is determined with the result of the comparison.

If an exemplary embodiment comprises an “and/or” conjunction between a first feature and a second feature, this is to be read to mean that the exemplary embodiment according to one embodiment contains both the first feature and the second feature, and contains either just the first feature or just the second feature according to another embodiment.

### REFERENCE SYMBOLS

100 actuator device

105 motor

110 transmission

115 actuator

120 device

125 rotational movement

130 linear movement

135 control signal

200 target position

205 motor voltage

210 motor current

215 motor temperature

220 position reconstruction device

225 speed

230 travel time

235 reconstructed position

245 regulating device

250 comparison device

300 engine characteristic

310 integrating device

315 gear ratio translation factor

400 other engine characteristic

500 method for moving an actuator in an actuator device to a target position

505 determining step

510 determining step

515 detecting step

520 generating step

525 comparison step

1. A method for moving an actuator in an actuator device to a target position, wherein the actuator device comprises at least a motor, a transmission, and the actuator coupled to the motor via the transmission, and wherein the method comprises:
determining, by a device comprising at least one processing device, a rotational rate of the motor based on a motor voltage, a motor current, and a motor temperature;
ascertaining, by the device, a speed of the actuator based on the rotational rate and a gear ration translation factor of the transmission;
determining, by the device, a reconstructed position of the actuator based on the speed and a travel time; and
generating a control signal configured to cause the actuator to move to the target position based, at least in part, on the reconstructed position.

2. The method according to claim 1, further comprising:
comparing the target position with the reconstructed position, wherein the control signal for controlling the motor is determined using a result of the comparison.

3. The method according to claim 1, further comprising:
determining the reconstructed position by integrating the speed over the travel time.

4. The method according to claim 1, further comprising:
determining the rotational rate based on an engine characteristic.

5. The method according to claim 1, further comprising:
determining, by the device, an intermediate rotational rate using the motor current, the motor temperature, and another engine characteristic, wherein the rotational rate is determined using the intermediate rotational rate, the motor voltage, and a correction factor.

6. The method according to claim 1, wherein the control signal is configured to provide a voltage for moving the actuator to the target position on the motor.

7. A device for moving an actuator in an actuator device to a target position, the device comprising:
at least one interface configured to receive a motor voltage, a motor current, and a motor temperature for a motor, wherein the motor is coupled to the actuator via a transmission; and
at least one processing device coupled to the interface and configured to:
determine a rotational rate of the motor based on the motor voltage, the motor current, and the motor temperature;
ascertain a speed of the actuator based on the rotational rate and a pear ration translation factor of the transmission;
determine a reconstructed position of the actuator based on the speed and a travel time; and
generate a control signal configured to cause the actuator to move to the target position based, at least in part, on the reconstructed position.

8. An actuator device the motor, the transmission, the actuator, and the device according to claim 7.

9. A tangible machine-readable memory having stored thereon a computer program that, when executed by a computing device, cause the computing device to perform a method comprising:
determining a rotational rate of a motor based on a motor voltage, a motor current, and a motor temperature, wherein the motor is coupled to an actuator via a transmission;
ascertaining a speed of the actuator based on the rotational rate and a pear ration translation factor of the transmission;
determining a reconstructed position of the actuator based on the speed and a travel time; and
generating a control signal configured to cause the actuator to move to a target position based, at least in part, on the reconstructed position.

10. (canceled)

11. The tangible machine-readable memory according to claim 9, wherein the computer program, causes the computing device to perform the method further comprising:
comparing the target position with the reconstructed position; and
generating the control signal based, at least in part, on a result of the comparison.

12. The tangible machine-readable memory according to claim 9, wherein the computer program, causes the computing device to perform the method further comprising:
determining the reconstructed position by integrating the speed over the travel time.

13. The tangible machine-readable memory according to claim 9, wherein the computer program, causes the computing device to perform the method further comprising:
determining the rotational rate based on an engine characteristic.

14. The tangible machine-readable memory according to claim 9, wherein the computer program, causes the computing device to perform the method further comprising:
determining an intermediate rotational rate using the motor current, the motor temperature, and another engine characteristic; and
determining the rotational rate using the intermediate rotational rate, the motor voltage, and a correction factor.

15. The device of claim 7, wherein the at least one processing device is further configured to:
compare the target position with the reconstructed position; and
generate the control signal based, at least in part, on a result of the comparison.

16. The device of claim 7, wherein the at least one processing device is further configured to:
determine the reconstructed position by integrating the speed over the travel time.

17. The device of claim 7, wherein the at least one processing device is further configured to:
determine the rotational rate based on an engine characteristic.

18. The device of claim 7, wherein the at least one processing device is further configured to:
determine an intermediate rotational rate using the motor current, the motor temperature, and another engine characteristic; and
determine the rotational rate using the intermediate rotational rate, the motor voltage, and a correction factor.

19. The device of claim 7, wherein the control signal is configured to provide a voltage for moving the actuator to the target position on the motor.
